(19) United States
(12) Patent Application Publication
(10) Pub. No.: US 2010/0164695 A1
(43) Pub. Date: Jul. 1, 2010

(54) Electronic Disk-Type Horn And Horn Using Photointerrupter

(76) Inventor: Sang-Kyu Choi, Chungnam (KR)

Correspondence Address: ST. ONGE STEWARD JOHNSTON & REENS, LLC, 986 BEDFORD STREET, STAMFORD, CT, 06905-5619, US

(21) Appl. No.: 12/640,650

(22) Filed: Dec. 17, 2009

(30) Foreign Application Priority Data
Dec. 25, 2008 (KR) 10-2008-0134000
Dec. 25, 2008 (KR) 10-2008-0134002

(51) Int. Cl. G08B 3/10

(52) U.S. Cl. 340/384.71; 340/384.73

(57) ABSTRACT

The present invention relates to an electronic disk-type horn having no contact point and a non-contact horn using a photointerrupter. The electronic disk-type horn generates a sound, and includes a switch circuit for selectively supplying current to the coil, a pulse generation timer circuit for periodically providing a pulse to the switch circuit, and a pulse ratio adjustment circuit for adjusting ON/OFF times of one period of the pulse. Further, the horn using a photointerrupter includes a light blocking panel for blocking a light emitting device and a light receiving device to prevent light emitted from the light emitting device from reaching the light receiving device, a switch circuit for selectively supplying current to the coil, and a photointerrupter including the light emitting device and the light receiving device, the photointerrupter controlling the switch circuit.

### CROSS-REFERENCE TO RELATED APPLICATIONS

The present application claims priority of Korean patent application No. 10 2008 0134000 filed on Dec. 25, 2008 and Korean patent application No. 10 2008 0134002 filed on Dec. 25, 2008, the content of which is incorporated herein by reference.

### FIELD OF THE INVENTION

The present invention relates, in general, to horns for vehicles, and, more particularly, to an electronic disk-type horn having no contact point and a non-contact horn using a photointerrupter.

### BACKGROUND OF THE INVENTION

Generally, horns are warning devices for proving a warning when a vehicle is moving and are classified into disk-type horns and shell-type horns according to the method of resonance, and into electric (contact) horns and electronic horns according to the method of operation.

As shown in FIG. 1A, in an electric disk-type horn, when a horn switch 140 is closed, current passes through both ends of the switch, and then flows back into the terminals of a storage battery 105 after passing through a coil via the contact point 131 of a stand and the contact point of a spring 132. In this case, when current flows, an iron core 120 which a coil is wound is magnetized to act as an electromagnet and draws an armature 113. The armature 113 pushes the spring while being drawn toward the iron core 120. While the spring being conducted by making contact with the stand is pushed downwards by the armature, current does not flow any longer. When current does not flow any longer, the iron core 120 loses electromagnetic force, and thus the armature 113 returns to its original position by the elastic force of a diaphragm 112 coupled to the armature 113. When the armature 113 returns to its original position, the spring that was pushed by the armature 113 comes into contact with the stand again because of its own elastic force, and thus current flows through the iron core 120. When the current flows through the iron core 120, the iron core 120 acts as an electromagnet, and the armature 113 is drawn again. By repeating the above operations, the horn generates warning sound.

In this case, the vibration frequency of the horn is determined by the time required for the reciprocation of the armature 113 attributable to the elastic force of the diaphragm 112 coupled to the armature.

The above-described contact disk-type horn is configured such that the diaphragm 112 and a resonator 111 are coaxially fixed to the armature 113 and such that sound generated by the diaphragm 112 is amplified by the resonator 111 using resonance. Such a contact disk-type horn requires a structure for controlling current flowing through the coil so as to generate a magnetic force due to the internal structure thereof. This structure is characterized in that, since large current capable of magnetizing the coil is controlled through contact points attached to the stand and the spring, a large spark occurs on the contact points when the stand comes into contact with the spring and is thereafter separated from the spring. In this way, a switching method using contact points is disadvantageous in that damage to the contact points is caused by a spark and the degree of the damage to the contact points becomes serious in proportion to the number of times the horn is used, thus decreasing the lifespan of the horn, and in that the spark occurring at the time of performing switching may be the cause of radio noise and Electromagnetic Interference (EMI) noise that may cause other electronic systems to malfunction.

Further, since the temperature of contact points increases due to the sparks, degradation may ensue, and the oxidization of contact points becomes accelerated, so that the conductivity of the contact points decreases, thus resulting in a conduction failure.

As a method of improving such a conduction failure, a non-contact disk-type horn in which an electric contact point is removed from an existing electric disk-type horn has been developed.

Further, as a scheme which does not use a contact point, an electronic horn using a frequency (pulse) generation circuit has been proposed, as shown in FIG. 1B. However, this electronic horn is disadvantageous in that a relatively large number of electronic parts are required, and expensive Integrated Circuits (ICs) such as a Central Processing Unit (CPU) or the like are required to generate pulses, thus increasing costs. Further, such an electronic horn is disadvantageous in that it can be normally operated only when a frequency suitable to the restoring force of a diaphragm is generated, but, when the electronic horn is exposed to a high-temperature environment such as the vicinity of the engine of a traveling vehicle, the characteristic values of respective electronic parts (a condenser, a resistor, a crystal oscillator, etc.) which control the frequency will vary due to variation in the temperature characteristics of the electronic parts, and thus the oscillation frequency varies.

When the oscillation frequency varies in this way, there is a problem because the frequency resonance with a restoration period attributable to the elastic force of a diaphragm causing vibration is shifted, and thus the tone color of the horn becomes deteriorated and the level of sound decreases.

### SUMMARY OF THE INVENTION

Accordingly, the present invention has been made keeping in mind the above problems occurring in the prior art, and an object of the present invention is to provide an electronic disk-type horn in which electric contact points that are the principal factors causing both an operation failure during the use of the horn and the shortening of the lifespan of the horn may be removed, and a horn using a photointerrupter (photo-sensor) in a non-contact switch system without causing abrasion, instead of contact points which are the principle factors causing both an operation failure during the use of the horn and the shortening of the lifespan of the horn.

In detail, in order to solve all the problems attributable to sparks occurring in the conventional electric (contact) horn, the present invention provides a non-contact horn which can eliminate sparks and noise by changing a switching method from a conventional contact switching method to a pulse driving method which does not use contact points, and by using a photointerrupter (photo-sensor).

In order to accomplish the above object, the present invention provides an electronic disk-type horn, the horn generating a sound by repeating an operation in which current flows through a coil wound around an iron core, the iron core is magnetized, and an armature is then attracted, comprising a switch circuit for selectively supplying current to the coil, a pulse generation timer circuit for periodically providing a pulse to the switch circuit, and a pulse ratio adjustment circuit for adjusting ON/OFF times of one period of the pulse.

Preferably, the pulse ratio adjustment unit comprises a variable resistor and varies a ratio of the ON time to OFF time of the pulse by varying a resistance of the variable resistor.

Preferably, the electronic disk-type horn further comprises a constant voltage circuit for causing a constant voltage to be applied to the pulse generation timer circuit, or a reverse polarity blocking circuit for preventing a reverse voltage from being applied to the switch circuit.

Preferably, the switch circuit is fixed to a body of the horn.

Further, in order to accomplish the above object, the present invention provides a horn using a photointerrupter, the horn generating a sound by repeating an operation in which current flows through a coil wound around an iron core, the iron core is magnetized, and an armature is then attracted, comprising a light blocking panel for blocking a light emitting device and a light receiving device to prevent light emitted from the light emitting device from reaching the light receiving device, a switch circuit for selectively supplying current to the coil, a photointerrupter including the light emitting device and the light receiving device, the photointerrupter controlling the switch circuit in such a way that, when the light emitted from the light emitting device reaches the light receiving device, the switch circuit is turned on, whereas when the light blocking panel is interposed between the light emitting device and the light receiving device, and the light emitted from the light emitting device is blocked by the light blocking panel in order to prevent the light from reaching the light receiving device, the switch circuit is turned off.

Preferably, the light blocking panel is arranged on the armature and is moved along with the armature, and the photointerrupter is arranged on a stand and is configured to adjust times for light blocking and release of light blocking depending on a relative position of the light blocking panel and the photointerrupter.

Preferably, the horn using a photointerrupter further comprises a constant voltage circuit for causing a constant voltage to be applied to the photointerrupter, or a reverse polarity blocking circuit for preventing a reverse voltage from being applied to the switch circuit.

### BRIEF DESCRIPTION OF THE DRAWINGS

FIGS. 1A and 1B are diagrams showing conventional horns, FIG. 1A illustrating a contact horn and FIG. 1B illustrating an electronic horn;

FIG. 2 is a circuit diagram showing an electronic disk-type horn according to a first embodiment of the present invention;

FIG. 3 is another circuit diagram showing an electronic disk-type horn according to a first embodiment of the present invention;

FIG. 4 is a diagram showing an embodiment to which the electronic disk-type horn according to the first embodiment of the present invention is applied;

FIG. 5 is a circuit diagram showing a horn using a photointerrupter according to a second embodiment of the present invention; and

FIGS. 6A to 6E are diagrams showing an embodiment to which the horn using a photointerrupter according to the second embodiment of the present invention is applied, FIG. 6A illustrating the coupling of a light blocking panel, FIGS. 6B and 6C illustrating the coupling of a photointerrupter, and FIGS. 6D and 6E illustrating a brief view showing the internal construction of the horn.

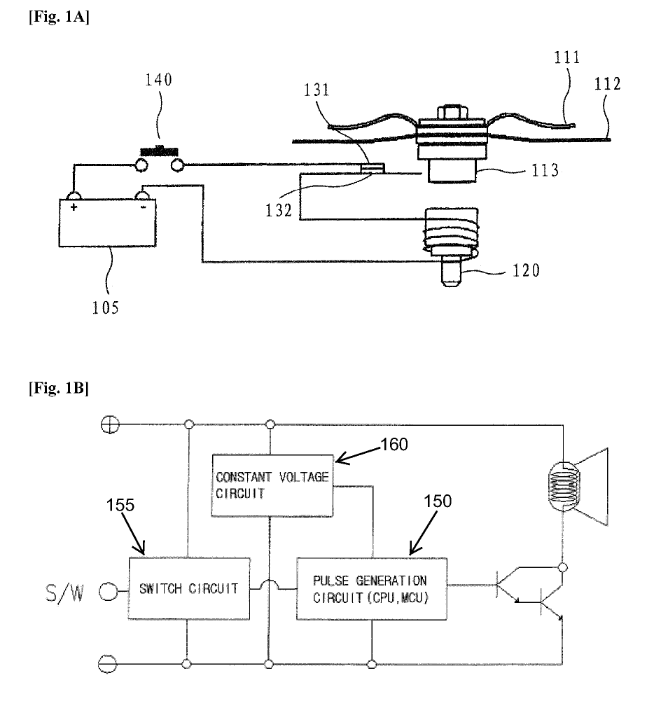

### DETAILED DESCRIPTION OF THE INVENTION

Hereinafter, embodiments of the present invention will be described in detail with reference to the attached drawings. With regard to an electronic disk-type horn having no contact point, a description will be made with reference to a first embodiment, and with regard to a non-contact horn using a photointerrupter, a description will be made with reference to a second embodiment.

### First Embodiment

In the first embodiment, an electronic disk-type horn having no contact point will be described.

The embodiment is configured to include a pulse generation circuit 150 for generating a frequency in conformity with the characteristics of the spring of a diaphragm, a constant voltage circuit 160 for causing a constant voltage to be applied to the pulse generation circuit 150, and a switch circuit 155 using a Field Effect Transistor (FET) for switching the magnetizing current of a coil using a generated pulse, in order to solve the above technical problems.

The construction of the present invention will be described in detail with reference to FIG. 2.

A diode D2 is a reverse polarity blocking circuit, and functions to block power so as to prevent the horn of the present invention from being damaged when Direct Current (DC) power is connected with the polarities reversed.

A resistor R1, a constant voltage diode ZD1 (zener diode) and a condenser C1 constitute a constant voltage circuit. When an abnormal voltage equal to or greater than a regulation voltage is applied to the constant voltage diode ZD1, the constant voltage diode ZD1 is operated as if it were short-circuited, and thus allows current attributable to the abnormal voltage to flow into the ground. In contrast, when a voltage less than the regulation voltage is applied to the constant voltage diode ZD1, the constant voltage diode ZD1 shuts off the circuit, thus enabling current from a power source to flow into a pulse generation timer circuit U1. In this way, a constant voltage is applied to the pulse generation timer circuit U1 or the like.

Meanwhile, the condenser C1 of the constant voltage circuit is ordinarily charged and is discharged when an abnormal voltage is applied, thus enabling the voltage applied to the pulse generation timer circuit U1 to be more constant.

The constant voltage circuit is a circuit for maintaining a constant voltage in this way so that the pulse generation timer circuit U1 can generate a pulse having a uniform ON/OFF ratio without being influenced by variation in supply voltage.

A circuit composed of resistors R6, R7 and R9 and a condenser C2 is a pulse ratio adjustment circuit for setting the ON/OFF times of a square wave pulse so that the ON/OFF times of the square wave pulse are maintained at a uniform ratio in order to smoothly vibrate the diaphragm 212 of the horn through the pulse generation timer circuit U1.

Since the horn is characterized by times required for the curve (bending) and restoration thereof depending on the properties of the material of the diaphragm 212, good sound may be output when these times are suitably set, otherwise an offensive sound may be output. That is, a good sound may be output by suitably adjusting the bending time and the restoration time in response to the ON/OFF times of the square wave pulse. Therefore, in the present invention, the ON/OFF times are adjusted by adjusting the resistance of a variable resistor, thus enabling an optimal sound suitable for the characteristics of the diaphragm 212 to be output.

That is, the ratio of ON time to OFF time is given by:

ON/OFF ratio=R9/(R6+R7+2*R9)

Therefore, when the resistor R7 is set to a variable resistor and the resistance thereof is adjusted, the optimal ON/OFF ratio is obtained, and thus the optimal sound may be output.

A circuit composed of resistors R3 and R4 and an FET Q2 is a switch circuit configured to allow current to flow through a coil U2 only during the time for which the pulse generated by the pulse generation timer circuit U1 is ON in association with the generated pulse.

The disk-type horn of the present invention can generate ideal sound when the diaphragm 212 vibrates at a suitable ratio of ON time to OFF time, that is, a ratio of an ON time of 65% to an OFF time of 35%, depending on the characteristics of a carbon steel sheet used as the diaphragm 212. Accordingly, as described above, the resistor R7 is used as the variable resistor so that the times of the pulse can be adjusted in conformity with the characteristics of the diaphragm 212.

Further, in order to overcome the problem of an oscillation pulse changing due to variation in the characteristics of electronic parts in a high-temperature environment because of the characteristics of use of a vehicle, the condenser C2 is implemented as a metalized polyester film condenser that is relatively robust to temperature variation.

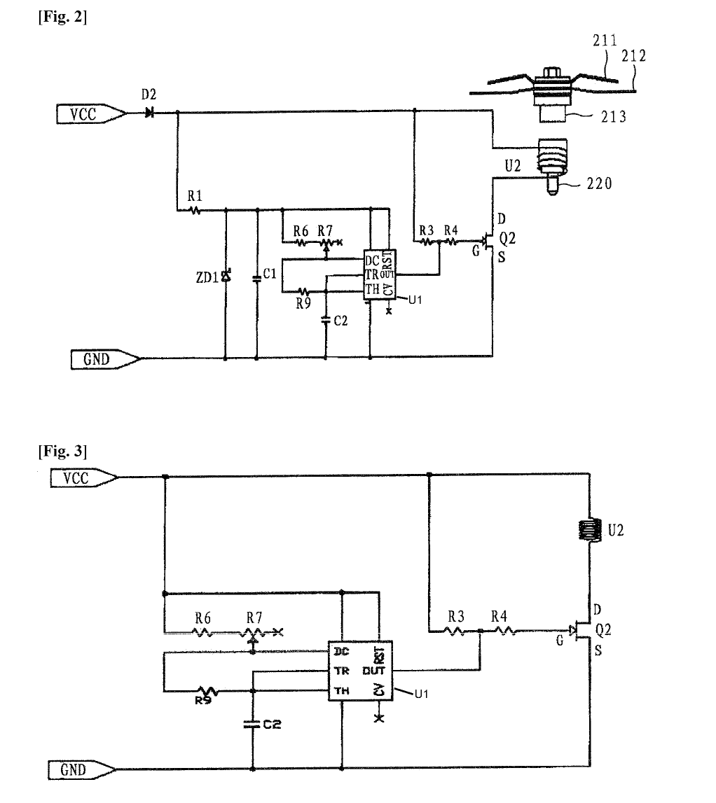

In the above embodiment, the reverse polarity blocking circuit and the constant voltage circuit are not necessarily required and may be selectively added. That is, as shown in FIG. 3, it is possible to omit both the reverse polarity blocking circuit and the constant voltage circuit or either of the two circuits and then construct the horn.

Next, the driving sequence of the diaphragm 212 will be described in detail.

First, while positive power is supplied to the gate G of the FET Q2 through the resistors R3 and R4 connected to DC power VCC, the drain D and the source S of the FET Q2 are electrically connected, and current flows through the coil U2, and thus the coil U2 acts as an electromagnet. At this time, the armature 213 to which the diaphragm 212 and the resonator 211 are coupled is attracted to the iron core 220 acting as the electromagnet. The armature 213 is attracted during the ON time of the pulse generated through the third terminal of the pulse generation timer circuit U1. Meanwhile, during the OFF time, the positive power is connected to the ground GND through the third terminal of the pulse generation timer circuit U1 via the resistor R3. Accordingly, during the OFF time, the drain D and the source S of the FET Q2 are electrically disconnected, so that current allowing the coil U2 to act as an electromagnet does not flow, and thus the armature 213 attracted to the electromagnet is restored to its original position due to the spring force of the diaphragm 212.

A procedure in which the armature 213 is attracted during the ON time of the square wave pulse and is restored during the OFF time is repeated. By repeating the procedure, the diaphragm 212 vibrates, and thus the horn generates sound.

In this case, when the time for which the diaphragm 212 is restored by its own elastic force becomes identical to the OFF time of the pulse, the optimal warning sound is generated. When the OFF time is set shorter than this, the diaphragm 212 is attracted again before being restored to its original position, so that the diaphragm 212 cannot sufficiently vibrate, thus making it impossible for the horn to generate a satisfactory sound.

The square wave pulse may be generated using an Operational Amplifier (OP AMP) circuit or other circuits, as well as the general-purpose pulse generation timer circuit used in the present invention.

An FET Q2 used for switching is a switching device for controlling output current according to an input voltage, and is implemented as an FET Q2 having an extremely small ON resistance of about 0.1Ω is used, thus enabling current flowing through the coil U2 to be switched. Alternatively, it is possible to implement a circuit using a typical power transistor, but there is a disadvantage in that, since ON resistance is large, much heat is generated in proportion to the magnitude of flowing current, and thus a sufficient heat-proof design is required.

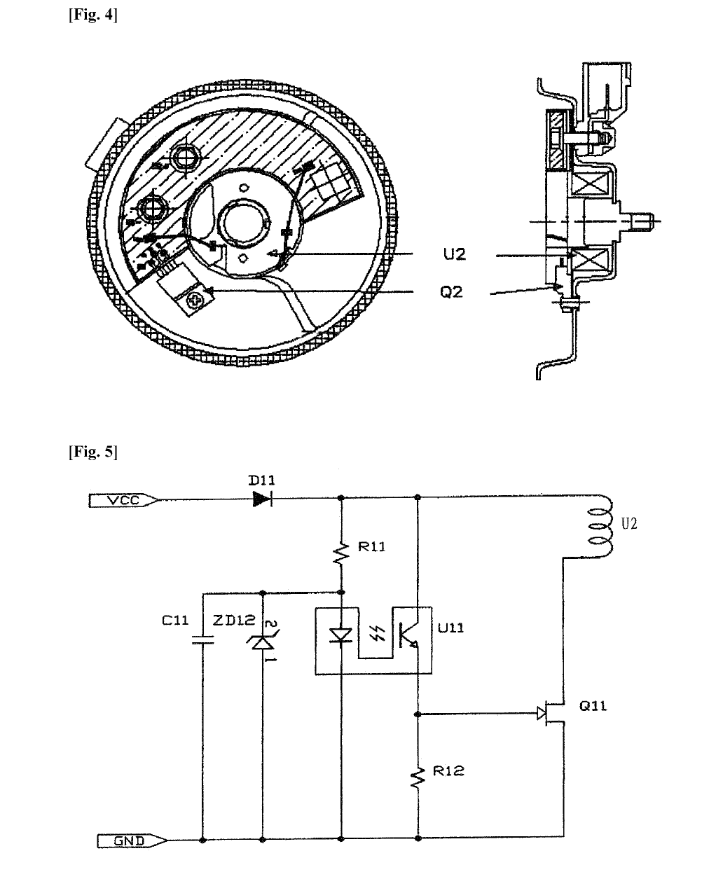

Therefore, in the present invention, as shown in FIG. 4, the FET Q2 is directly fixed to the body of the horn so that Joule's heat, generated during the current switching of the FET Q2, may be radiated using the metal sheet of the body of the horn. Further, as the FET Q2, an insulating-type FET Q2, a fixed portion of which is molded using an insulator so that the FET Q2 is electrically isolated from the body of the horn, is used.

### Second Embodiment

In the second embodiment, a non-contact horn using a photointerrupter U11 will be described below.

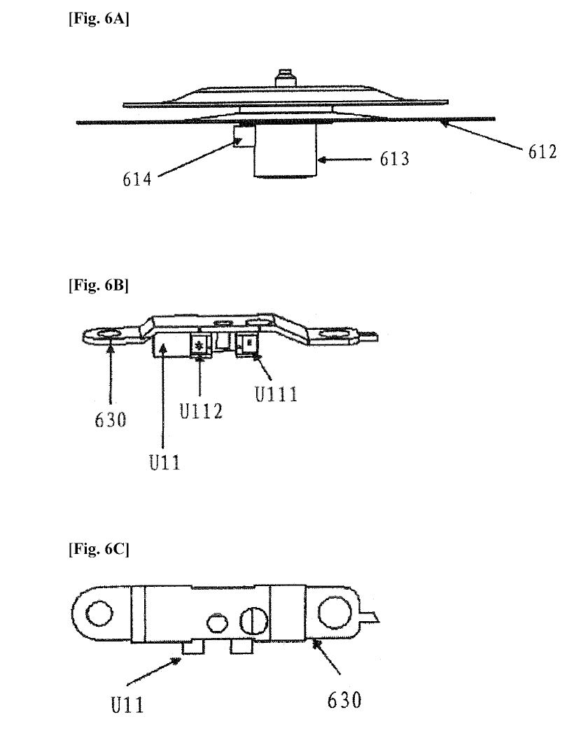

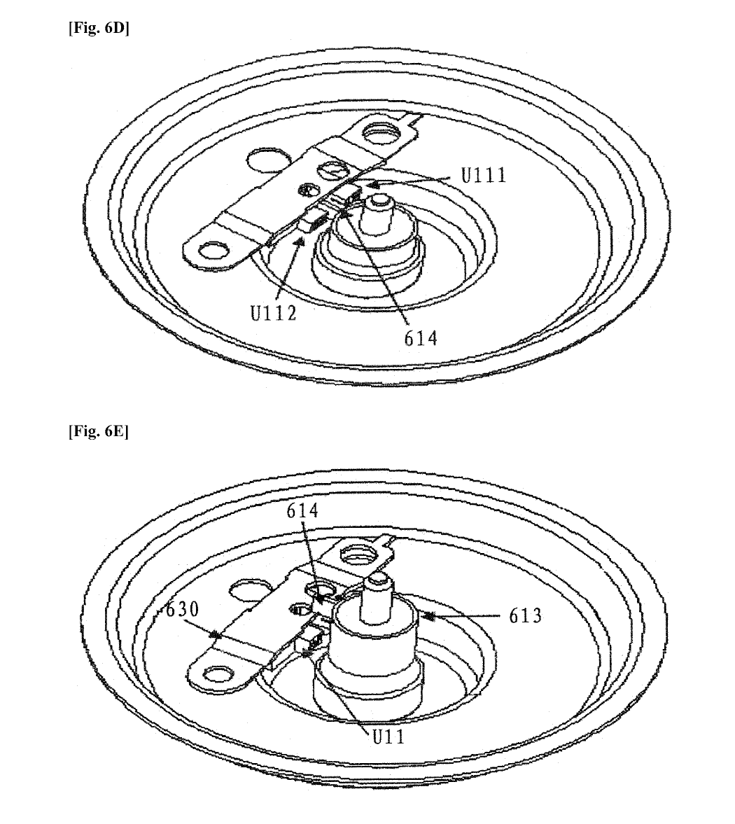

The present embodiment is configured such that, as shown in FIG. 5, a voltage is applied to the gate of a transistor Q11 according to the output of a photointerrupter (photo-sensor) U11 in which a light emitting unit U112 and a light receiving unit U111 from FIG. 6 are integrated. As a result, the drain and source of the transistor Q11 are electrically connected, so that current flows through a coil U2. Accordingly, the coil U2 acts as an electromagnet, and thus an armature 613 is attracted to the electromagnet.

When the armature 613 is attracted, a light blocking panel 614 attached to the armature 613 blocks light from the photointerrupter U11, as shown in FIG. 6, thus blocking the output of the photointerrupter U11. Accordingly, the gate voltage of the transistor Q11 is blocked, and current flowing through the coil U2 is also interrupted, and thus the coil U2 loses a magnetic force.

In this case, the armature 613 that was attracted is restored to its original position by the elastic force of the diaphragm 612, and the light blocking panel 614 connected to the armature 613 moves upwards, thus enabling light to pass through the photointerrupter U11. By repeating this procedure, the diaphragm 612 vibrates, and thus a warning sound is generated.

In the circuit diagram (of FIG. 5) according to the present invention, a diode D11 is a reverse polarity blocking circuit, and is a protection device connected in series with the DC power so as to prevent the polarities of DC power from influencing the circuit of the present invention even if the polarities of externally connected DC power change.

A zener diode ZD12 and a condenser C11 constitute a constant voltage circuit which allows a constant voltage to be applied to the light emitting unit U112 regardless of the magnitude of the input supply voltage.

That is, when an abnormal voltage equal to or greater than a regulation voltage is applied to the constant voltage diode ZD12, the zener diode ZD12 is operated as if it were short-circuited, so that all current attributable to the abnormal voltage is caused to flow into the ground. In contrast, when a voltage less than the regulation voltage is applied to the zener diode ZD12, the zener diode ZD12 shuts off the circuit to allow current from the power source to flow through the photointerrupter U11. In this way, abnormal voltage is prevented from being applied to the photointerrupter U11 or the like, thus enabling the photointerrupter U11 to emit light at a uniform ratio.

Meanwhile, the condenser C11 of the constant voltage circuit is ordinarily charged and is discharged when an abnormal voltage is applied, thus enabling the voltage applied to the photointerrupter U11 to be more constant.

In the present invention, the reverse polarity blocking circuit and the constant voltage circuit are not essential and may be selectively employed according to the circumstances.

In more detail, a description will be made with reference to FIGS. 6A to 6E showing an embodiment to which the second embodiment is applied. That is, the photo-sensor (photointerrupter) U11 is a sensor for conducting a light receiving device when light emitted from the light emitting unit U112 reaches the light receiving unit U111. The photointerrupter U11 has a function of blocking the output of the light receiving device when the light is blocked.

The horn of the present invention has a structure in which the photointerrupter U11 is attached to a stand 630 to enable its position to be adjusted similar to conventional contact horns, and the light blocking panel 614 made of a metal or a plastic (resin) material is attached to the armature 613 so as to block light at the time of attraction, as shown in FIGS. 6D and 6E, so that the transistor Q11 is connected to control the magnetizing current of the coil U2 according to the output of the photointerrupter U11 (light receiving device).

Further, in the prior art, the position of the stand was adjusted by manipulating a screw or the like, thereby controlling the time for which contact points are separated from or come into contact with each other. Similarly, the photointerrupter is arranged on the stand, and the light blocking panel is installed on the armature. Further, the vertical position of the stand, that is, the relative position of the light blocking panel and the stand (photointerrupter), is adjusted using a screw or the like, thus enabling the time for which the photointerrupter U11 blocks light or releases light blocking to be controlled.

By way of this adjustment, a sound that is most suitable for the diaphragm may be output. The reason for this is that the horn is characterized by times required for the curve (bending) and restoration thereof depending on the properties of the material of the diaphragm, and thus a good sound may be output if the times are suitably set, otherwise an offensive sound may be output. That is, by suitably adjusting the bending time and the restoration time, a good sound may be generated. Therefore, the present invention may output an optimal sound suitable for the characteristics of the diaphragm by adjusting the times required for light blocking and the release of light blocking through the adjustment of the position of the stand.

As described above, the present invention having the above construction is advantageous in that, in an electronic disk-type horn, an optimal warning sound is generated by setting the ratio of the ON time to OFF time of an oscillation pulse to 65:35 in conformity with the elastic force of a diaphragm, a variable resistor is provided to enable the ratio of the ON time to OFF time of the oscillation pulse to be easily adjusted, and current flowing through a coil is switched using a semiconductor FET, thus acquiring products having an improved lifespan compared to a conventional contact horn, and eliminating electromagnetic radiation noise attributable to sparks at contact points.

Further, the present invention is advantageous in that, in a non-contact horn using a photointerrupter, sparks can be eliminated using a photo-sensor called a photointerrupter, instead of using contact points causing electromagnetic noise, and current flowing through a coil can be switched in a non-contact manner while the frequency characteristics of a conventional contact horn remain unchanged, so that sparks do not occur, thus eliminating electromagnetic noise, and so that the problem of shortening the lifespan of products due to abrasion of contact points attributable to sparks is solved, thus enabling the operating lifespan of the horn to be greatly elongated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electronic disk-type horn, the horn generating a sound by repeating an operation in which current flows through a coil wound around an iron core, the iron core is magnetized, and an armature is then attracted, comprising:
a switch circuit for selectively supplying current to the coil;
a pulse generation timer circuit for periodically providing a pulse to the switch circuit; and
a pulse ratio adjustment circuit for adjusting ON/OFF times of one period of the pulse.

2. The electronic disk-type horn according to claim 1, wherein the pulse ratio adjustment unit comprises a variable resistor and varies a ratio of the ON time to OFF time of the pulse by varying a resistance of the variable resistor.

3. The electronic disk-type horn according to claim 1, further comprising a constant voltage circuit for causing a constant voltage to be applied to the pulse generation timer circuit.

4. The electronic disk-type horn according to claim 1, further comprising a reverse polarity blocking circuit for preventing a reverse voltage from being applied to the switch circuit.

5. The electronic disk-type horn according to claim 1, wherein the switch circuit is fixed to a body of the horn.

6. A horn using an interrupter, the horn generating a sound by repeating an operation in which current flows through a coil wound around an iron core, the iron core is magnetized, and an armature is then attracted, comprising:
a light blocking panel for blocking a light emitting device and a light receiving device to prevent light emitted from the light emitting device from reaching the light receiving device;
a switch circuit for selectively supplying current to the coil; and
a photointerrupter including the light emitting device and the light receiving device, the photointerrupter controlling the switch circuit in such a way that, when the light emitted from the light emitting device reaches the light receiving device, the switch circuit is turned on, whereas when the light blocking panel is interposed between the light emitting device and the light receiving device, and the light emitted from the light emitting device is blocked by the light blocking panel in order to prevent the light from reaching the light receiving device, the switch circuit is turned off.

7. The horn using a photointerrupter according to claim 6, wherein:
the light blocking panel is arranged on the armature and is moved along with the armature; and
the photointerrupter is arranged on a stand and is configured to adjust times required for light blocking and release of light blocking depending on a relative position of the light blocking panel and the photointerrupter.

8. The horn using a photointerrupter according to claim 6, further comprising a constant voltage circuit for causing a constant voltage to be applied to the photointerrupter.

9. The horn using a photointerrupter according to claim 6, further comprising a reverse polarity blocking circuit for preventing a reverse voltage from being applied to the switch circuit.
